(19) United States
(12) Patent Application Publication
(10) Pub. No.: US 2023/0323195 A1
(43) Pub. Date: Oct. 12, 2023

(54) ENCAPSULATED PROPPANT PARTICLES FOR HYDRAULIC FRACTURING

(71) Applicant: Saudi Arabian Oil Company, Dhahran (SA)

(72) Inventors: Ataur Malik, Abqaiq (SA); Sultan Attiah, Udhailiyah (SA)

(21) Appl. No.: 17/717,580

(22) Filed: Apr. 11, 2022

(51) Int. Cl. C09K 8/80; C09K 8/92; C09K 8/594; C09K 8/72

(52) U.S. Cl. CPC C09K 8/805; C09K 8/92; C09K 2208/26; C09K 8/72; C09K 8/594

(57) ABSTRACT

Proppants for use in hydraulic fracturing and methods for making the proppants are provided. An exemplary proppant includes a proppant particle, and a first layer of active well treatment chemical disposed on the proppant particle.

### TECHNICAL FIELD

The present disclosure is directed to encapsulated proppant particles for hydraulic fracturing application.

### BACKGROUND

The flow of fluids from and to reservoirs is often enhanced through hydraulic fracturing of the rock layers in the reservoir. Hydraulic fracturing treatment is performed to advance well productivity from a hydrocarbon bearing reservoir or well injectivity in an injection well. Hydraulic fracturing treatment with crosslinked gel and proppant is more common in sandstone reservoirs while acid fracturing treatment is typically performed in carbonate reservoirs. In either case, the objective is to obtain sufficient fracture conductivity or dimensionless fracture conductivity to provide desired enhancement in well productivity or injectivity.

Carbonate reservoirs are usually heterogeneous and consist of limestone, dolomites, and anhydrites that have different reactivity to acid at reservoir conditions. The objective of the acid fracturing treatment is to achieve differential etching to generate and maintain fracture conductivity and fracture half-length throughout the producing life of the well. However, production decline at faster than normal rate and early production loss are often experienced as result of loss of differential etching and fracture conductivity. To overcome this challenge, proppant fracture treatment has been attempted in the carbonate reservoir as well. However, placement of proppant in terms of optimum size, volume, concentrations, and the like, has often not been favorable in naturally fractured carbonate reservoirs to consider it as a preferred practical option.

In other sedimentary rocks, such as sandstone and shale, hydraulic fracturing with crosslinked gel, linear gel or slick water and natural sand or proppant are used for enduring the fracture opening, and providing sufficient fracture conductivity to enhance production. The desired production is often not achieved due to insufficient fracture conductivity as result of excessive fluids damage, poor recovery of pumped fluids, and the like.

### SUMMARY

An embodiment described herein provides a proppant for use in hydraulic fracturing. The proppant includes a proppant particle, and a first layer of active well treatment chemical disposed on the proppant particle.

Another embodiment described herein provides a method for treating a formation using an encapsulated proppant particle. The method includes preparing an encapsulated proppant particle, including a capsule disposed over a proppant particle wherein the capsule includes an active well treatment chemical. The method further includes mixing a fracturing fluid, suspending the encapsulated proppant particle in the fracturing fluid, and injecting the fracturing fluid into the formation.

### BRIEF DESCRIPTION OF DRAWINGS

FIG. 1 is a schematic drawing of a wellbore illustrating the formation of fractures in a formation from a fracturing operation.

FIG. 2A is a cross-sectional drawing of a proppant particle encapsulated with a single layer of a well treatment chemical.

FIG. 2B is a cross-sectional drawing of a proppant particle encapsulated with two layers of well treatment chemical.

FIG. 3 is a process flow diagram of a method for treating a formation using an encapsulated proppant particle.

### DETAILED DESCRIPTION

Examples described herein provide a proppant for hydraulic fracturing. The proppant includes a proppant particle with a layer of active well treatment chemical encrusted, or disposed, on the proppant particle, for example, over the exterior surface. In some examples, multiple layers are applied, such as an outer solvent layer and an inner acid layer. The layer of active well treatment chemical may be removed and activated in fractures, when the proppant particle contacts the sides during pumping and fracture closes on proppant after the hydraulic fracture treatment.

A polymer coating may be applied over an exterior surface of the layer from activation or abrasion until the proppant particle reaches a target location, such as in a fracture. At the target location, heat, stress, compression, or fluids cause the polymer coating to break down and release the active well treatment chemical. For example, when the proppant particle is trapped in a fracture, the pressure, effective stress and heat can cause the polymer layer to fail, releasing the active well treatment chemical disposed on the proppant particle. If the active well treatment chemical selected is an acid, release of the acid may dissolve the rock around the proppant particle, increasing the size of the stimulated reservoir volume. This will increase the conductivity of the formation, for example, through the synergy of the acid etching and a higher retention of the proppant pack in the fractures.

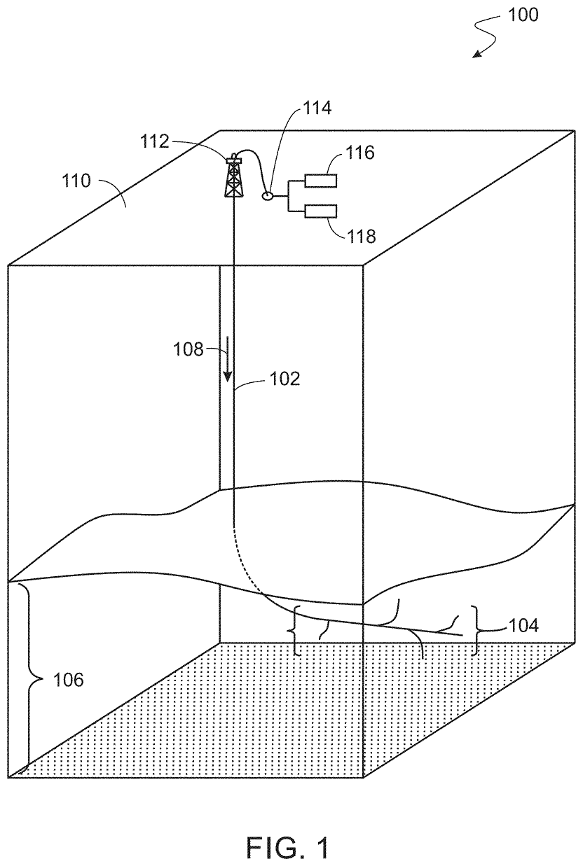

FIG. 1 is a simplified schematic drawing 100 of a wellbore 102 illustrating the formation of fractures 104 in a formation 106 from a fracturing operation. Hydraulic fracturing is an operation in which fracturing fluid 108 is pumped into the formation 106 through the wellbore 102 at high pressure and high volume to create the fractures 104. Generally, proppant particles are carried by the fracturing fluid and placed in the fractures 104 to hold the fractures 104 open after the pressure is released. If proppant particles were not used, the fractures 104 would decrease in size and may close and seal shut. As described herein, the proppant particles are encrusted with one, or more, active well treatment chemicals to enhance the fracturing operation.

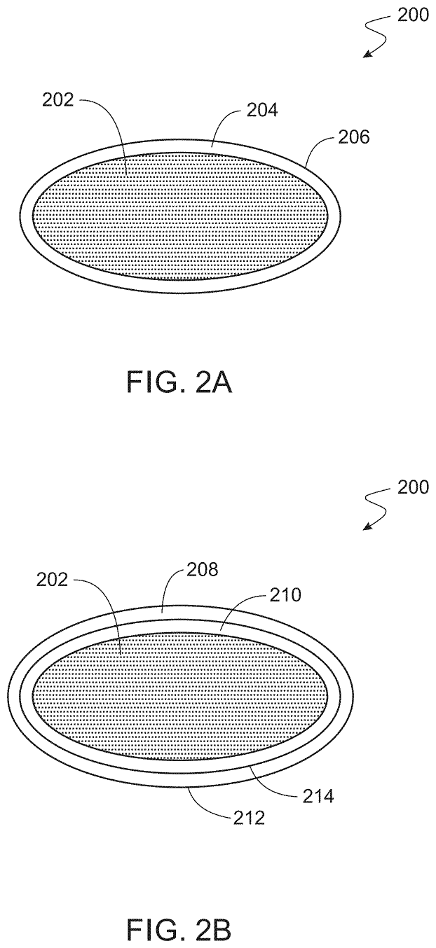

As used herein, an active well treatment chemical is a chemical that directly interacts with the rock, fluids, or mechanical structures in a well. For example, an active well treatment chemical includes acids, solvents, chelating agents, gel breakers, foaming agents, or the like, as discussed further with respect to FIGS. 2A and 2B. Further, active well treatment chemicals include materials that protect tubulars and other structures in the well, such as corrosion inhibitors and the like.

Proppant particles can include silica sand, ceramic particles, sintered bauxite, or any number of other natural or synthetic materials. The proppant particles can have various sizes, shapes, and strengths as determined by the depth of the formation, rock types, fracturing pressure, temperature, and the like.

The fracturing fluid 108 that can be used to carry the proppant particles to a fracture includes water-based fluids, hydrocarbon based fluids, oil-in-water emulsions, water-in-oil emulsions, and the like. In some examples, the fracturing fluid 108 includes a water-based fluid comprising a dissolved gelling compound, such as guar gum or other polysaccharides, that is added to the fracturing fluid 108 with a cross-linking agent, such as a borate compound, to increase the viscosity of the fracturing fluid 108. This can be used to enhance the amount of proppant particles that can be carried by the fluid. In other examples, the fracturing fluid 108 is a slickwater that includes friction-reducing polymers, such as polyacrylamides, that are not gelled, but are utilized to allow higher pumping rates at lower power. Other additives that can be added to the fracturing fluid 108 include biocides, corrosion inhibitors, and the like.

The fracturing fluid 108 is pumped from the surface 110 using apparatus coupled to the wellbore 102. In examples this may include a wellhead 112 coupled to the wellbore 102 and a slurry pump 114. The slurry pump 114 is used to pump fracturing fluid 108 from tanks 116 and 118. In some examples, the tanks 116 and 118 both contain a slurry that includes previously blended proppant particles. In other examples, one tank 116 or 118 includes a slurry a proppant particles, while the other tank includes the basic fluids and chemicals for the fracturing fluid 108. In these examples, the slurry pump 114 combines the material from the tanks 116 and 118 for injection. It would be understood by one of ordinary skill in the art that this is a simplified schematic 100, and that the equipment at the surface will include additional units not shown, such as multiple tanks, multiple slurry pumps, blending apparatus, control systems, valve systems, and the like.

FIG. 2A is a cross-sectional drawing of a proppant 200 that includes a proppant particle 202 encapsulated with a layer 204 of an active well treatment chemical. As described herein, in various examples, the proppant particle 202 includes a silica sand, a ceramic, a sintered bauxite, and any number of other materials, both natural and synthetic. In some examples, the proppant particle 202 has a cross-linked polymer layer, which is inert in the formation, but increases the strength of the proppant particle 202. For example, a silica sand particle may have a layer of epoxy cross-linked over the outside the particle to increase the crush strength.

In various examples, the active well treatment chemical in the layer 204 is an acid, a solvent, a chelating agent, or a gel breaker. The active well treatment chemical can be a solid or a liquid. For example, a liquid may be included as the layer 204 with an external polymer capsule 206 disposed over the layer 204 to hold it in place. This may be performed by coating the proppant particle 202 with a semipermeable membrane, then exposing the coated proppant particle to the solution or solvent. Material will diffuse through the membrane filling the interior. Once the interior of the membrane is filled, and hydrostatic pressure is equalized, the semipermeable membrane can be coated with a stronger material, such as an epoxy resin, if desired.

Acids that can be used include inorganic (mineral) acids as well as organic acids. Organic acids may be in solid form. Solvents that can be used include aromatic solvents, non-aromatic solvents, or mutual solvents. Chelating agents that can be used include ethylenediaminetetraacetic acid (EDTA), hydroxyethyl ethylenediaminetetraacetic acid (HEDTA), diethylenetriaminepentaacetic acid (DTPA), or any number of other chelating agents. Gel breakers that can be used include oxidative compounds, such as peroxydisulfates, ammonium persulfates, sodium bromate, or potassium bromate, among others. The chemical additives can be foamed with N₂, CO₂, or both, prior to the encapsulation in the external polymer capsule 206. Alternatively, chemical compounds that release gases upon degradation may be used as the active well treatment chemical, as discussed herein.

In various embodiments, the layer 204 or external polymer capsule 206 is water resistant, and acid resistant if needed, and maintains integrity at the surface and under pumping conditions. However, the layer 204 or external polymer capsule 206 will crush, decompose, and degrade as a function of bottom hole temperature, for example, once the fracture closes on the proppant 200.

In one example, the active well treatment chemical is an acid that is deposited on the proppant particle 202 to form the layer 204. The acid can be blended with other materials as binders to adsorb a liquid, increase the adhesion to the proppant particle 202, or increase the strength of the layer 204. For example, the acid may be blended with a clay, such as a kaolinite, a montmorillonite-smectite, or and illite, among others, to form a slurry. The slurry can then be applied to the proppant particle 202 and dried to form the layer 204. In some embodiments, the strength of the layer 204 is controlled by the drying temperature. Drying at higher temperatures, for example, may partially sinter the clay increasing the strength of the layer 204. Other materials may be used as binders in forming the layer 204, such as cement, hard polymers, and the like. The binder may consist of micro and nano-particles. The capsules can consist of internal porosities to provide high surface area and contain required absorbed chemicals. In an example, hydrophobic silica nanoparticles are used to adsorb an acid, forming a dry acid. The hydrophobic silica nanoparticles can then be gelled in a slurry with a proppant particle 202, and then dried to coat the proppant particle 202.

Both a binder and an external polymer capsule 206 can be used to protect the layer 204. For example, after drying the binder, an external polymer capsule 206 could be applied over the binder. The external polymer capsule 206 can be selected based on the strength needed. In some examples, an epoxy-based polymer is used, with the degree of cross-linked controlled by the ratio of hardener to monomer to control the breaking strength.

In other examples, an emulsion polymerization process can be used to form the external polymer capsule 206. For example, the proppant 200 can be suspended in a water phase in a water-in-oil emulsion. The continuous oil phase includes a monomer, while the water phase, or the binder of the proppant 200 itself, includes a polymerization initiator. The polymerization of the monomer would then coat proppant particles suspended in the emulsion with the polymer. The coated proppant particles could then be dried to prepare for use.

Any number of other active well treatment chemicals can be blended with clay to form the layer 204, such as gel breakers, foaming agents, chelating agents, and the like. Multiple active well treatment chemicals can be blended together as solids in a slurry to allow activation once the layer 204 is broken. For example, a foaming agent, such as a polyethoxalated surfactant, can be blended with a gas-forming agent, such as a nitrosoamine compound that forms nitrogen gas during degradation. Breaking the layer 204 could then result in the formation of a foam as the foaming compound degrades.

Depending on application, multiple layers of active well treatment chemicals can be used. This is discussed further with respect to FIG. 2B.

FIG. 2B is a cross-sectional drawing of a proppant 200 that includes a proppant particle 202 encapsulated with two layers 208 and 210 of well treatment chemical. One or both of the two layers 208 and 210 can be coated with a polymer layer 212 and 214 as described with respect to FIG. 2A.

In case of multiple layers, an outer layer 208 and outer polymer layer 212, if present, will be engineered to degrade faster than the inner layer 210 and inner polymer layer 214, if present. The controlled and systematic release of encapsulated chemical additives allows each active well treatment chemical to perform an independent function in contact with reservoir rock and fluids after the proppant placement. This can be used to provide additional and sustainable fracture conductivity, for example, by increasing the retained proppant particles permeability and through the acid dissolution of cementitious rock matrix and differential etching in a single hydraulic fracture treatment.

In an example, the proppant 200 has an outer layer 212 containing solvent and an inner layer 210 containing acid layered over the proppant particle 202. In this example, when the proppant particle 202 is placed into the carbonate reservoir during a hydraulic fracturing treatment, solvent is released from the outer layer 208 first as function of temperature, exposure time, layer strength, and effective stress on the proppant 200. The solvent released from the outer layer 208 makes the rock surface in the formation water wet. The inner layer 210 then degrades to release the acid. As a result of the solvent released from the outer layer 208, the acid release from the inner layer 210 more effectively reacts with the rock face for differential etching. Accordingly, the total effective fracture conductivity is enhanced from both conductivity of the proppant and differential etching resulted from the acid.

In another example, the proppant 200 is layered with a solvent as the outer layer 208 and a chelating agent as the inner layer 210 for use in hydraulic fracturing of a clastic reservoir. As the layers 208 and 210 dissolve, the active well treatment chemicals in the layers increase fracture conductivity and pumped fluid recovery through additional dissolution of rock face. Further, the active well treatment chemicals destabilize the crosslinked polymer gel used to increase the viscosity of the fracturing fluid to carry the proppant into the fractures. Accordingly, this combination of active well treatment chemicals in layers over the proppant increases reservoir and proppant pack porosity. In a similar example, the proppant 200 is layered with a single layer including a chelating agent or acid.

The number of layers is not limited to two, as three or more layers may be used if desirable. In these combinations, the selection of the active well treatment chemicals may be based on the combinations of chemicals desired. For example, an outer layer may include a surfactant to increase the wettability of the rock in the formation, and an inner layer may include an acid to form wormholes in the rock, or to increase the depth of penetration of the proppant particle.

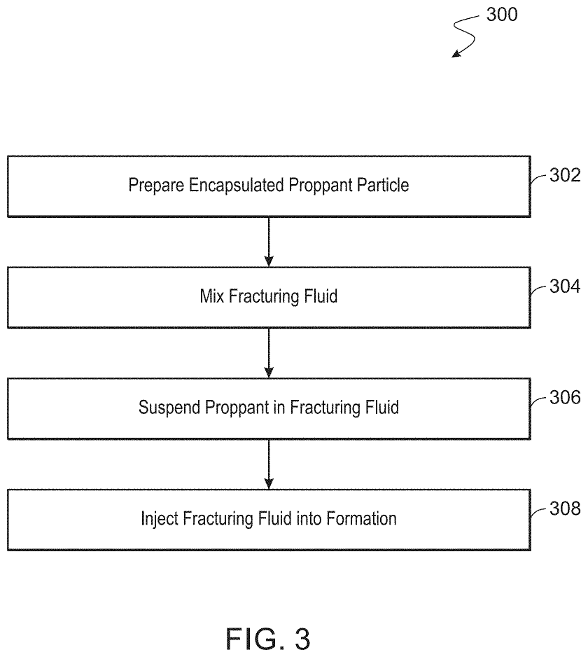

FIG. 3 is a process flow diagram of a method 300 for treating a formation using an encapsulated proppant particle. The method begins at block 302 with the preparation of an encapsulated proppant particle. The encapsulated proppant particle includes a capsule, or layer, disposed over a proppant particle wherein the capsule includes an active well treatment chemical.

In some examples, the encapsulated proppant particle is prepared by spraying the proppant particle with a liquid comprising the active well treatment chemical. The sprayed proppant particle is then dried to form the encapsulated proppant particle.

In some examples, the encapsulated proppant particle is prepared by mixing the active well treatment chemical with a binder to form a binder mixture, coating the proppant particle with the binder mixture to form a wet proppant particle, and drying the wet proppant particle to form the encapsulated proppant particle.

At block 304, a fracturing fluid is mixed. Mixing the fracturing fluid is performed by incorporating fracturing chemicals into a base fluid. The base fluid may be water, oil, or an emulsion. The fracturing chemicals can include a gelling polymer, a cross-linker, a friction reducing polymer, a biocide, an acid, surfactants, stabilizer, breaker, pH buffer, clay stabilizer or a chelating agent, or any combinations thereof. The fracturing fluids can be energized or foamed with N2 and/or CO2.

At block 306, the encapsulated proppant particle is suspended in the fracturing fluid. In some examples, the encapsulated proppant particle are suspended in the fracturing fluid by mixing the encapsulated proppant particle into a fracturing fluid stream during the injection of the fracturing fluid into the formation. In some examples, the encapsulated proppant particle are suspended in the fracturing fluid by mixing the encapsulated proppant particle into a tank holding the mixed fracturing fluid.

At block 308, the fracturing fluid is injected into the formation. In some examples, the fracturing fluid is injected into the formation using a high pressure pump to create fractures and to place the encapsulated proppant particle into the fractures.

### Embodiments

An embodiment described herein provides a proppant for use in hydraulic fracturing. The proppant includes a proppant particle, and a first layer of active well treatment chemical disposed on the proppant particle.

In an aspect, the proppant particle includes silica sand. In an aspect, the proppant particle includes a ceramic. In an aspect, the proppant particle includes sintered bauxite. In an aspect, the proppant particle includes an internal particle with an external layer of an inert polymer, wherein the active well treatment chemical is disposed over the inert polymer.

In an aspect, the proppant includes a polymer layered over the active well treatment chemical.

In an aspect, a second layer of active well treatment chemical is disposed over the first layer of active well treatment chemical, wherein the second layer of active well treatment chemical differs from the first layer of active well treatment chemical. In an aspect, a polymer layer is disposed between the first layer of active well treatment chemical and the second layer of active well treatment chemical.

In an aspect, the active well treatment chemical in the first layer is selected to react with the active well treatment chemical in the second layer.

In an aspect, multiple layers of active well treatment chemicals are deposited over the proppant particle.

In an aspect, a polymer layer is deposited over the multiple layers of active well treatment chemicals.

In an aspect, the active well treatment chemical includes an acid.

In an aspect, the active well treatment chemical includes a gel breaker.

In an aspect, the active well treatment chemical includes a chelating agent, a solvent, a foaming agent, or an encapsulated gas, or any combinations thereof.

Another embodiment described herein provides a method for treating a formation using an encapsulated proppant particle. The method includes preparing an encapsulated proppant particle, including a capsule disposed over a proppant particle wherein the capsule includes an active well treatment chemical. The method further includes mixing a fracturing fluid, suspending the encapsulated proppant particle in the fracturing fluid, and injecting the fracturing fluid into the formation.

In an aspect, the method includes preparing the encapsulated proppant particle by spraying the proppant particle with a liquid including the active well treatment chemical, and drying the sprayed proppant particle to form the encapsulated proppant particle. In an aspect, the method includes preparing the encapsulated proppant particle by forming a slurry including the proppant particle in a liquid including the active well treatment chemical and drying the slurry to form the encapsulated proppant particle. In an aspect, the method includes preparing the encapsulated proppant particle by mixing the active well treatment chemical with a binder to form a binder mixture, coating the proppant particle with the binder mixture to form a wet proppant particle, and drying the wet proppant particle to form the encapsulated proppant particle.

In an aspect, the method includes mixing the fracturing fluid by incorporating fracturing chemicals into a base fluid, wherein the fracturing chemicals include a gelling polymer, a cross-linker, a friction reducing polymer, a biocide, surfactants, breaker, stabilizers, pH buffer, an acid, or a chelating agent, or any combinations thereof.

In an aspect, the method includes energizing the fracturing fluid for foaming with N₂, CO₂, or both.

In an aspect, the method includes suspending the encapsulated proppant particle in the fracturing fluid by mixing the encapsulated proppant particle into a fracturing fluid stream during the injection of the fracturing fluid into the formation. In an aspect, the method includes suspending the encapsulated proppant particle in the fracturing fluid by mixing the encapsulated proppant particle into a tank holding the mixed fracturing fluid.

In an aspect, the method includes injecting the fracturing fluid into the formation using a high pressure pump to create fractures and to place the encapsulated proppant particle into the fractures.

Other implementations are also within the scope of the following claims.

1. A proppant for use in hydraulic fracturing, comprising:
a proppant particle;
a first layer of active well treatment chemical disposed on the proppant particle;
a polymer layer disposed over the first layer; and
a second layer of active well treatment chemical disposed over the polymer layer.

2. The proppant of claim 1, wherein the proppant particle comprises silica sand.

3. The proppant of claim 1, wherein the proppant particle comprises a ceramic.

4. The proppant of claim 1, wherein the proppant particle comprises sintered bauxite.

5. The proppant of claim 1, wherein the proppant particle comprises an internal particle with an external layer of an inert polymer, wherein the active well treatment chemical is disposed over the inert polymer.

6. The proppant of claim 1, wherein the proppant comprises a polymer layered over the active well treatment chemical.

7. The proppant of claim 1, comprising a second layer of active well treatment chemical disposed over the first layer of active well treatment chemical, wherein the second layer of active well treatment chemical differs from the first layer of active well treatment chemical.

8. (canceled)

9. The proppant of claim 7, wherein the active well treatment chemical in the first layer is selected to react with the active well treatment chemical in the second layer.

10. The proppant of claim 1, comprising multiple layers of active well treatment chemicals deposited over the proppant particle.

11. The proppant of claim 10, comprising a polymer layer deposited over the multiple layers of active well treatment chemicals.

12. The proppant of claim 1, wherein the active well treatment chemical comprises an acid.

13. The proppant of claim 1, wherein the active well treatment chemical comprises a gel breaker.

14. The proppant of claim 1, wherein the active well treatment chemical comprises a chelating agent, a solvent, a foaming agent, or an encapsulated gas, or any combinations thereof.

15. A method for treating a formation using an encapsulated proppant particle, comprising:
preparing an encapsulated proppant particle, comprising a capsule disposed over a proppant particle where in the capsule comprises an active well treatment chemical;
mixing a fracturing fluid;
suspending the encapsulated proppant particle in the fracturing fluid; and
injecting the fracturing fluid into the formation.

16. The method of claim 15, comprising preparing the encapsulated proppant particle by:
spraying the proppant particle with a liquid comprising the active well treatment chemical; and
drying the sprayed proppant particle to form the encapsulated proppant particle.

17. The method of claim 15, comprising preparing the encapsulated proppant particle by:
forming a slurry comprising the proppant particle in a liquid comprising the active well treatment chemical; and
drying the slurry to form the encapsulated proppant particle.

18. The method of claim 15, comprising preparing the encapsulated proppant particle by:
mixing the active well treatment chemical with a binder to form a binder mixture;
coating the proppant particle with the binder mixture to form a wet proppant particle; and
drying the wet proppant particle to form the encapsulated proppant particle.

19. The method of claim 15, comprising mixing the fracturing fluid by incorporating fracturing chemicals into a base fluid, wherein the fracturing chemicals comprise a gelling polymer, a cross-linker, a friction reducing polymer, a biocide, surfactants, breaker, stabilizers, pH buffer, an acid, or a chelating agent, or any combinations thereof.

20. The method of claim 15, comprising energizing the fracturing fluid for foaming with N₂, CO₂, or both.

21. The method of claim 15, comprising suspending the encapsulated proppant particle in the fracturing fluid by mixing the encapsulated proppant particle into a fracturing fluid stream during the injection of the fracturing fluid into the formation.

22. The method of claim 15, comprising suspending the encapsulated proppant particle in the fracturing fluid by mixing the encapsulated proppant particle into a tank holding the mixed fracturing fluid.

23. The method of claim 15, comprising injecting the fracturing fluid into the formation using a high pressure pump to create fractures and to place the encapsulated proppant particle into the fractures.
